(19) United States
(12) Patent Application Publication
(10) Pub. No.: US 2025/0384659 A1
(43) Pub. Date: Dec. 18, 2025

(54) SIMILARITY-BASED SUBSET SELECTION OF LABELED IMAGES

(71) Applicant: The Toronto-Dominion Bank, Toronto (CA)

(72) Inventors: Cheng Chang, Toronto (CA); Keyu Long, Toronto (CA); Ted Li, Toronto (CA); Himanshu Rai, Toronto (CA); Maksims Volkovs, Toronto (CA)

(73) Assignee: The Toronto-Dominion Bank, Toronto (CA)

(21) Appl. No.: 19/239,320

(22) Filed: Jun. 16, 2025

Related U.S. Application Data
(60) Provisional application No. 63/659,887, filed on Jun. 14, 2024.

(51) Int. Cl. G06V 10/74; G06V 10/25; G06V 10/44; G06V 10/762; G06V 10/764

(52) U.S. Cl. CPC G06V 10/761; G06V 10/25; G06V 10/44; G06V 10/762; G06V 10/764

(57) ABSTRACT

An example operation may include at least one of receiving, from a source dataset, a plurality of labeled images, receiving, from a target dataset, a plurality of images associated with a different visual domain, extracting, from each of the plurality of labeled images and each of the plurality of images from the target dataset, one or more feature representations indicative of visual characteristics, grouping the plurality of labeled images into a plurality of image clusters based on similarity among the one or more feature representations, comparing the one or more feature representations of each of the plurality of image clusters to the one or more feature representations of the plurality of images from the target dataset to determine a similarity ranking for each image cluster, selecting, from the plurality of image clusters, a subset of labeled images based on the similarity ranking and a selection limit, and storing the subset of labeled images in a memory.

### CROSS-REFERENCE TO RELATED APPLICATIONS

This application claims priority to U.S. Provisional Application No. 63/659,887, filed on Jun. 14, 2024, the entire disclosure of which is incorporated by reference herein.

This application is related via subject-matter to U.S. application Ser. No. 18/817,329, filed on Aug. 28, 2028, entitled “IMAGE CLASSIFICATION MODEL TRAINING USING LATENT-BASED CLUSTER FILTERING AND ALIGNED SUBSET SELECTION”, filed on Jun. 16, 2025, and entitled “CLASSIFIER-GUIDED DATASET COMPRESSION USING DISTRIBUTION-AWARE SELECTION”, filed on Jun. 16, 2025, the entire disclosures of which are incorporated by reference herein.

### BACKGROUND

Conventional machine learning systems often rely on full annotated datasets for training, leading to substantial computational overhead and inefficiencies in adapting to new or shifting target domains.

### SUMMARY

An instant apparatus includes a memory communicatively coupled to a processor, wherein the processor may perform at least one of receive, from a source dataset, a plurality of labeled images, receive, from a target dataset, a plurality of images associated with a different visual domain, extract, from each of the plurality of labeled images and each of the plurality of images from the target dataset, one or more feature representations indicative of visual characteristics, group the plurality of labeled images into a plurality of image clusters based on similarity among the one or more feature representations, compare the one or more feature representations of each of the plurality of image clusters to the one or more feature representations of the plurality of images from the target dataset to determine a similarity ranking for each image cluster, select, from the plurality of image clusters, a subset of labeled images based on the similarity ranking and a selection limit, and store, in the memory, the subset of labeled images.

An instant method includes at least one of An example operation may include at least one of receiving, from a source dataset, a plurality of labeled images, receiving, from a target dataset, a plurality of images associated with a different visual domain, extracting, from each of the plurality of labeled images and each of the plurality of images from the target dataset, one or more feature representations indicative of visual characteristics, grouping the plurality of labeled images into a plurality of image clusters based on similarity among the one or more feature representations, comparing the one or more feature representations of each of the plurality of image clusters to the one or more feature representations of the plurality of images from the target dataset to determine a similarity ranking for each image cluster, selecting, from the plurality of image clusters, a subset of labeled images based on the similarity ranking and a selection limit, and storing the subset of labeled images in a memory.

An instant computer readable storage medium comprises instructions, that when read by a processor, causes the processor to perform at least one of An example operation may include at least one of receiving, from a source dataset, a plurality of labeled images, receiving, from a target dataset, a plurality of images associated with a different visual domain, extracting, from each of the plurality of labeled images and each of the plurality of images from the target dataset, one or more feature representations indicative of visual characteristics, grouping the plurality of labeled images into a plurality of image clusters based on similarity among the one or more feature representations, comparing the one or more feature representations of each of the plurality of image clusters to the one or more feature representations of the plurality of images from the target dataset to determine a similarity ranking for each image cluster, selecting, from the plurality of image clusters, a subset of labeled images based on the similarity ranking and a selection limit, and storing the subset of labeled images in a memory.

### BRIEF DESCRIPTION OF DRAWINGS

FIG. 1 is a system diagram illustrating an operating environment of a software service, according to of the instant solution.

FIG. 2A is a system diagram illustrating integration of an AI model into any decision point, according to the instant solution.

FIG. 2B is a diagram illustrating a process for developing an AI model that supports AI-assisted computer decision points, according to the instant solution.

FIG. 2C is a diagram illustrating a process for utilizing an AI model that supports AI-assisted computer decision points according to instant solution.

FIG. 2D is a system diagram illustrating a chatbot service that utilizes an AI model.

FIG. 2E is a flow diagram illustrating training a visual model using selected images for classifying target data, according to the instant solution.

FIG. 3A is a system diagram illustrating an AI-assisted image classification architecture, according to the instant solution.

FIG. 3B is a process diagram illustrating latent-space feature extraction from annotated and target datasets, cluster formation and comparison, selection of refined training data, and classification of unlabeled images using a trained model, according to the instant solution.

FIG. 3C is a system diagram illustrating an inference architecture including feature extractors, cluster scoring, and subset selector, used for configuring a visual classification model based on selected training data, according to the instant solution.

FIG. 4A is a flow diagram illustrating a method for refining an annotated dataset using discrepancy scoring to reduce computational load and increase classification accuracy on non-annotated datasets, according to examples and features of the instant solution.

FIG. 4B is another flow diagram illustrating a method for determining latent discrepancy using embeddings, clustering via k-means, ranking by values, and selecting a refined training subset to increase model efficiency, according to examples and features of the instant solution.

FIG. 5 is a system diagram illustrating a computing environment according to the instant solution's example features, structures, or characteristics.

### DETAILED DESCRIPTION

Modern computer vision systems often rely on training data that is curated from a single visual domain, resulting in reduced performance when applied to target environments that differ in lighting, texture, background, or content distribution. In real-world deployment scenarios, such as industrial inspection, surveillance, or mobile perception, this domain mismatch leads to inaccurate classifications, excessive false positives, or degraded model confidence. Conventional approaches attempt to mitigate this challenge by retraining models with domain-specific data, but doing so is computationally intensive, time-consuming, and infeasible in environments with constrained resources or real-time requirements.

The instant solution provides a system that performs domain-aligned selection of labeled images by clustering a source dataset and ranking the resulting clusters based on feature-level similarity to a target dataset associated with a different visual domain. This enables efficient construction of a refined training subset, selected prior to deployment, hat enhances the performance of downstream visual classification models without requiring full retraining.

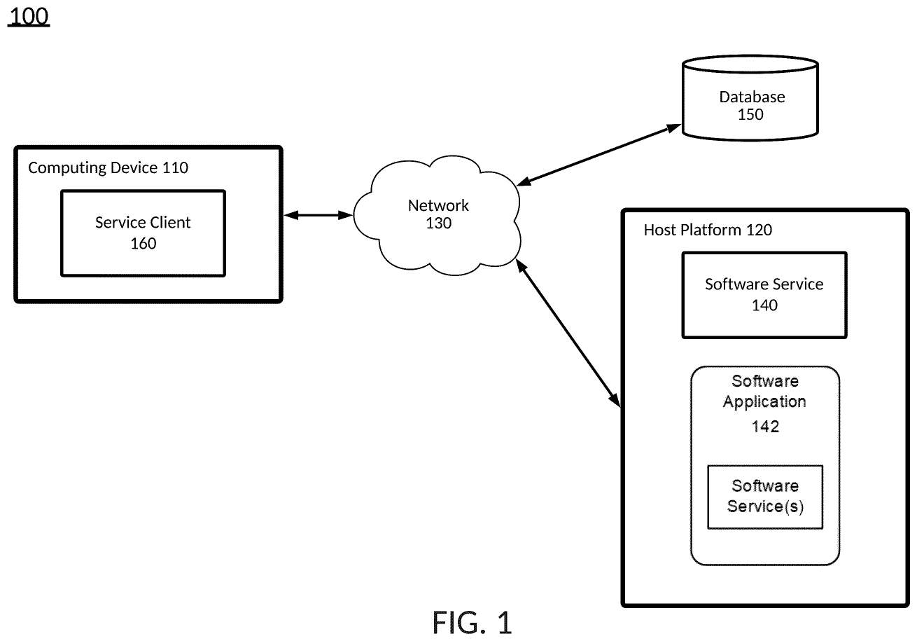

FIG. 1 is a system diagram 100 illustrating an example operating environment of the instant solution. As shown, at least one computing device 110, and a host platform 120 communicate via a network 130. The host platform 120 may host a software service 140. The software service 140 may communicate with at least one database 150 through a network 130 during the course of service execution. Each computing device 110 may host a service client 160, which communicates with a corresponding software service 140.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 130 is a computer network and may include at least one interconnected computer network. For example, network 130 may be or may include an Ethernet network, an asynchronous transfer mode (ATM) network, a wireless network, a telecommunications network or the like.

The software service 140 provides the service logic. It may provide at least one Application Programming Interface (API) for communicating with at least one service client 160. A “thick” user interface client that runs on a computing device 110 may utilize the APIs to communicate with the software service 140. Further, the software service 140 may provide hosted User Interfaces (UIs) that can be accessed through browser-based software on some computing devices 110.

The at least one service client 160 can enable service access for end users and may come in a variety of forms including, but not limited to, a mobile device application (“app”) or a web portal accessed via a browser on a computing device 110 such as a laptop or desktop computer.

Detailed descriptions of the architecture and operation of the optimized dataset reduction via cluster comparison and distribution scoring service in the instant solution are further described and depicted herein.

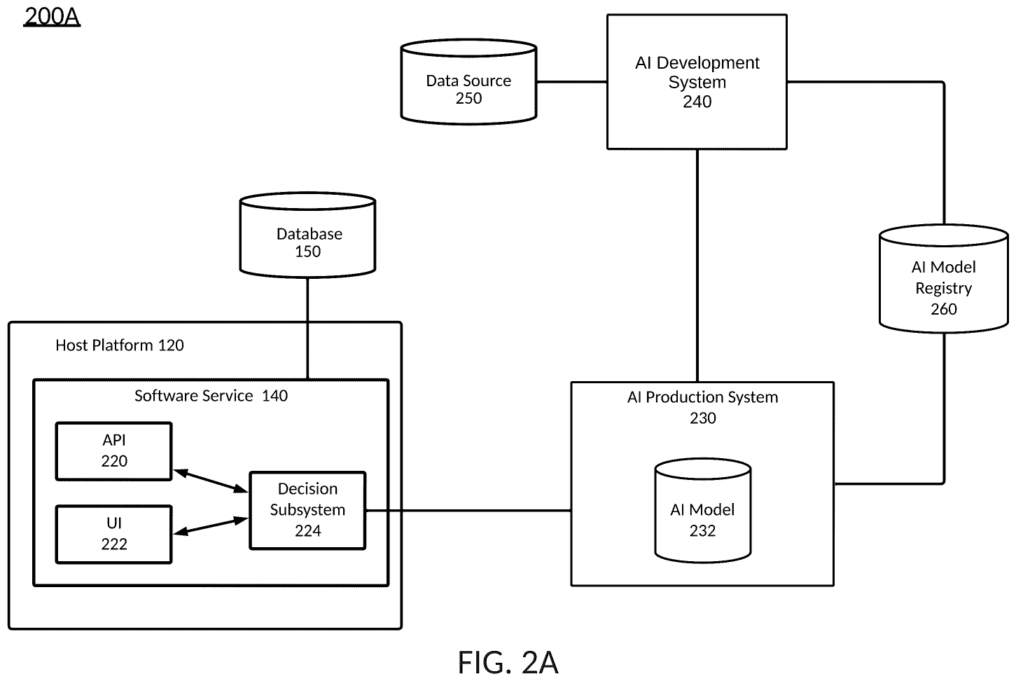

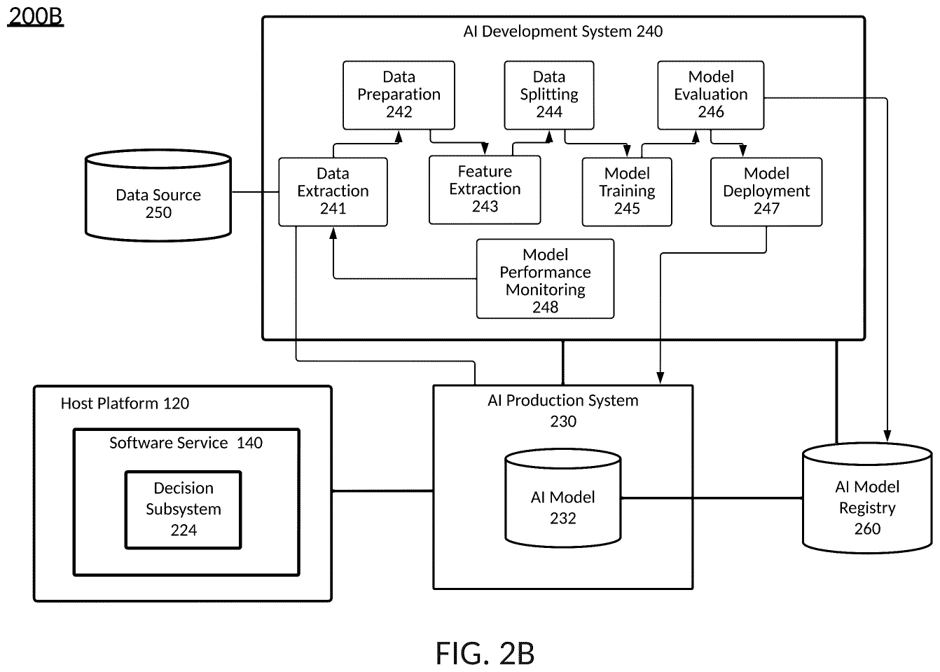

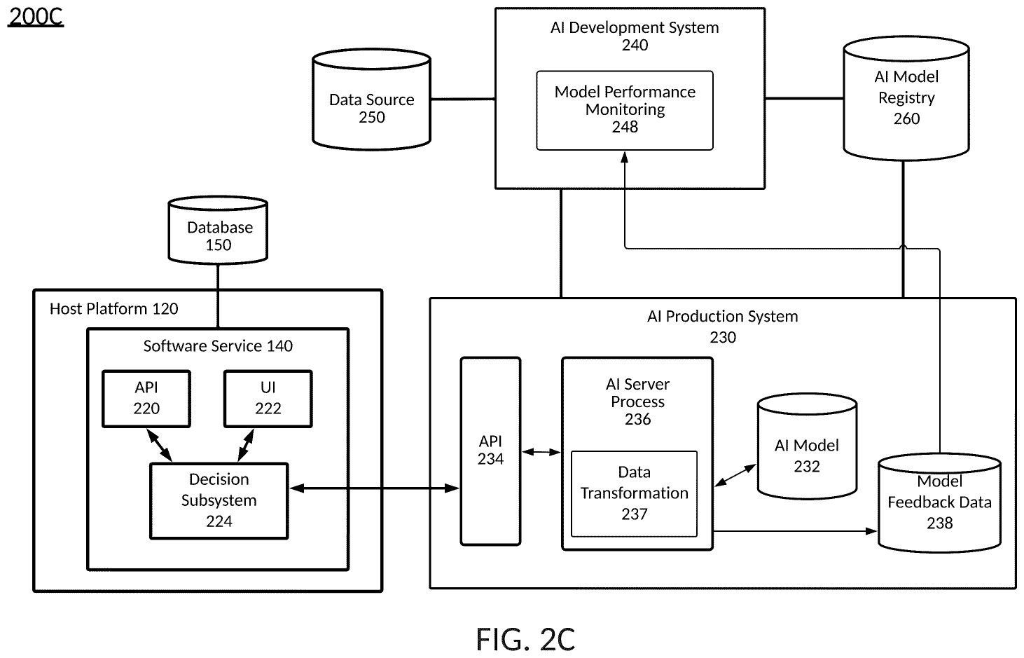

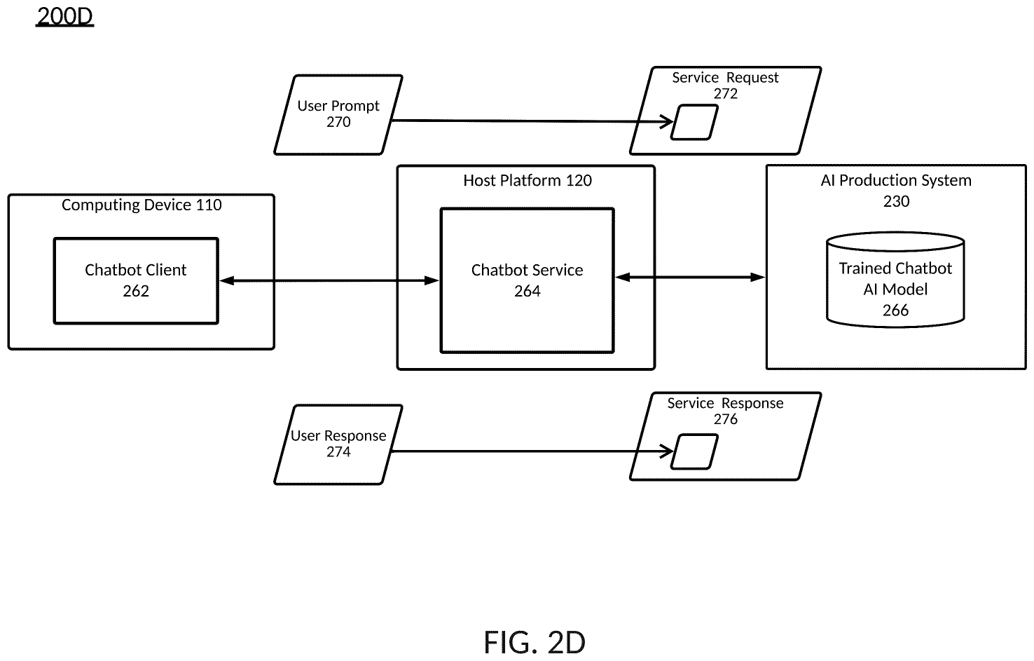

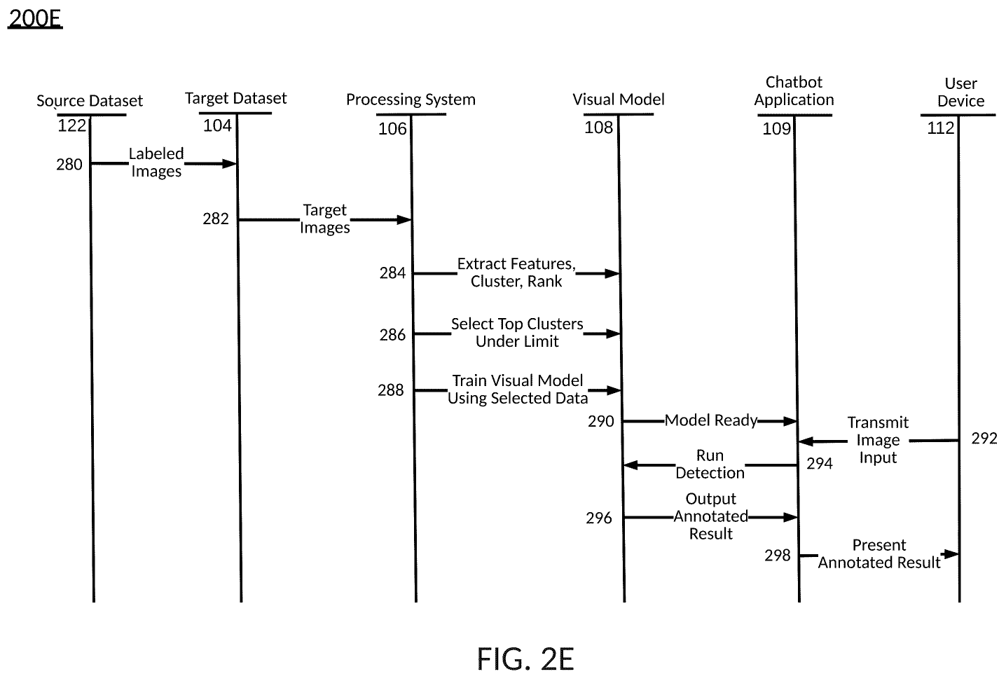

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. In an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140 (see FIGS. 1, 2A), executing on host platform 120 (see FIGS. 1, 2A) may provide at least one API 220 that enable interaction with other software components via a set of data definitions and protocols. In the instant solution, the at least one API provided may employ Simple Object Access Protocol (SOAP), Remote Procedure Calls (RPC), and Representational State Transfer (REST) techniques. The plurality of APIs 220 send data to at least one decision subsystem 224 of the software service 140 to assist in decision-making. The software service 140 stores data included in API requests or data generated during processing the API requests into at least one database 150 (see FIGS. 1, 2A). In some examples and features of the instant solution, software service 140 is a chatbot service.

Software service 140 may provide at least one user interface (UI) 222, such as a server-side hosted graphical user interface (GUI). The UIs 222 provided employ template-based frameworks, component-based frameworks, etc. These UIs 222 send data to at least one decision subsystem 224 of the software service 140 to assist with decision-making. The software service 140 stores data included in UI requests or data generated during processing the UI requests into at least one database 150.

Software service 140 may include at least one decision subsystem 224 that drive a decision-making process of the software service 140. The decision subsystems 224 receive data from at least one API 220 as input into the decision-making process. A decision subsystem 224 may receive data from at least one UI 222 as input to the decision-making process. A decision subsystem 224 may gather service configuration or historical execution data from at least one database 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes at least one AI model 232 that is executed to generate a response, such as, but not limited to, a prediction, a categorization, a UI prompt, etc. The AI model 232 has been trained to provide chatbot responses. An AI production system 230 is hosted on a server. The AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. The AI development system 240 utilizes feedback data from at least one AI production system 230 for new model development and/or existing model re-training. The AI development system 240 resides and executes on a server. The AI development system 240 is cloud hosted. The AI development system 240 is deployed in a distributed multi-node architecture. The AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. The AI model registry 260 is cloud-hosted. The AI model registry 260 resides in the AI production system 230. In some examples and features of the instant solution, the AI model registry 260 is a distributed database.

The instant solution operates within the AI model by utilizing the AI development system 240 to generate at least one AI model 232 that is configured using a subset of training images selected from a labeled dataset based on similarity to a separate target dataset. This subset is derived using latent-space analysis and clustering operations external to the AI model 232 but accessible by the AI production system 230 during model initialization. Once trained, the AI model 232 is stored in the AI model registry 260 and may be retrieved by the AI production system 230 to classify incoming image data. The training data, including both the source and target datasets, may originate from one or more data sources 250, which may be local or remote. By selecting the most relevant training images, the instant solution reduces compute demands on the AI production system 230 while preserving accuracy across visual domains.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. Historical model feedback data is extracted from at least one AI production system 230. The extracted data includes labeled image data from a source dataset and unlabeled image data from a target dataset, which are later analyzed to derive a refined training subset based on inter-domain visual similarity.

Once the data has been extracted during data extraction 241, it undergoes data preparation 242 for model training. This step involves statistical testing of the data to see how well it reflects real-world events, its distribution, the variety of data in the dataset, etc., and the results of this statistical testing may lead to at least one data transformation being employed to normalize at least one value in the dataset. Data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein. The data preparation step may include latent-space embedding of image features from both datasets to support downstream clustering and ranking operations.

Features of the data are identified and extracted during the feature extraction step 243. A feature of the data is internal to the prepared data from the data preparation step 242. A feature of the data requires a piece of prepared data from the data preparation step 242 to be enriched by data from another data source to be useful in developing the AI model 232. Identifying features may be a manual process or an automated process using at least one of the elements and/or functions described and/or depicted herein. Once the features have been identified, the values of the features are collected into a dataset that will be used to develop the AI model 232. This dataset may include cluster membership and similarity scores that indicate which labeled images in the source domain are most aligned with unlabeled images in the target domain.

The dataset output from the feature extraction step 243 is split 244 into a training and validation data set. The training data set is used to train the AI model 232, and the validation data set is used to evaluate the performance of the AI model 232 on unseen data. The training dataset may be restricted to a selected subset of the labeled source dataset based on inter-domain similarity, in order to increase performance and reduce computational cost.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results. The instant solution enables this tuning step to converge faster by training on visually relevant image clusters identified through a latent-space comparison and scoring process.

The AI model 232 is evaluated 246 in a staging environment (not shown) that resembles the target AI production system 230. This evaluation uses a validation dataset to ensure the performance in an AI production system 230 matches or exceeds expectations. The validation dataset from step 244 is used. At least one unseen validation dataset is used. The staging environment is part of the AI development system 240, and the staging environment is managed separately from the AI development system 240. Once the AI model 232 has been validated, it is stored in an AI model registry 260, where it can be retrieved for deployment and future updates. The model evaluation step 246 may be a manual process or an automated process using at least one of the elements and/or functions described and/or depicted herein.

The AI development system includes a user interface (not shown). The user interface may be used to manage the development system infrastructure, the steps 241-248 within the development system, the interim data transmitted between the various steps 241-248, and the data sources 250. The user interface may also present metrics related to cluster similarity rankings, image selection thresholds, or validation accuracy of models trained on refined subsets.

Once an AI model 232 has been validated and published to an AI model registry 260, it may be deployed during the model deployment step 247 to at least one AI production system 230. The performance of deployed AI model 232 is monitored 248 by the AI development system 240. AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

In one example, an AI development system 240 is configured to process input data and train an AI model 232, such as a machine learning model. The system receives data from at least one data source 250, and optionally one or more AI production systems 230, which may undergo a sequence of preprocessing steps before being used for training a predictive model. The AI development system 240 extracts data related to one or more of the instant features from at least one data source 250 in the data extraction stage 241. This extracted data is then processed through data preparation 242 to normalize or filter relevant information. Feature extraction 243 follows, where meaningful features are identified to increase model performance. The dataset is then split 244 into training and validation subsets. The instant solution further includes latent-space mapping and cluster formation to identify labeled training examples that are most visually aligned with the target dataset, and these are prioritized in the split 244 for training and evaluation.

The AI development system 240 (serving as a machine learning server) is directed to generate a predictive model based on machine learning of the data. The system initiates model training 245 using the prepared dataset. The AI development system 240 selects an appropriate machine learning algorithm and hyperparameters to optimize predictive accuracy. The trained model undergoes model evaluation 246 using validation data to assess performance. If the model meets predefined accuracy thresholds, it is deployed 247 to an AI production system 230 and registered in the AI model registry 260 for use in real-time decision-making. Because the model is trained on a filtered dataset aligned to the visual distribution of the target domain, the instant solution ensures that deployed models retain high accuracy while reducing training time and resource consumption.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. A request may include an AI model 232 identifier to be executed based on the type of request. A data payload (e.g., to be input to the AI model during execution) is included in the request. The data payload may include API 220 data from software service 140, UI 222 data from software service 140 or data from other software service 140 subsystems (not shown). The AI model 232 loaded by the AI production system 230 is a visual classification model trained using a refined subset of labeled source images that were selected based on their latent-space similarity to a target dataset. The API 234 may receive an image classification request in the form of one or more new target-domain images to be labeled using the trained model.

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. The response may result in an update to a UI 222 in software service 140. The response includes a request identifier that can be used later by the software service 140 to provide feedback on the performance of the AI model 232. A model feedback record may be added into a model feedback data 238 by the AI server process 236. The response generated by the AI server process 236 may include classification labels for incoming images based on the visual semantics learned from the refined training dataset, allowing domain-specific inference without retraining.

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. The response may result in an update to a UI 222 in software service 140. The response includes a request identifier that can be used later by the software service 140 to provide feedback on the performance of the AI model 232. A model feedback record may be added into a model feedback data 238 by the AI server process 236. The response generated by the AI server process 236 may include classification labels for incoming images based on the visual semantics learned from the refined training dataset, allowing domain-specific inference without retraining.

In particular, the instant solution leverages a pre-computed subset of source-labeled training images that are clustered and ranked for visual similarity against a target dataset associated with a specific domain. By pre-selecting and training the visual classification model on those clusters most aligned with the target domain, the model is primed to handle domain-specific inputs without requiring further retraining. During inference, the AI model 232 processes images from the target domain using feature mappings that were implicitly optimized for cross-domain similarity. As a result, the classification performance generalizes effectively across domains while avoiding the computational and data burdens associated with retraining the model for each new target environment.

The API 234 includes an interface to provide AI model 232 feedback after an AI model 232 execution response has been processed. This mechanism enables the requester to provide feedback on the accuracy of the AI model 232 results. The feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. The records in this model feedback data 238 are provided to model performance monitoring 248 in the AI development system 240. This model feedback data is streamed to the AI development system 240 or may be provided upon request. The model feedback records in the model feedback data 238 are used as an input for retraining the AI model 232. Feedback from inference results can indicate whether the refined subset remained optimal over time, triggering re-evaluation if cross-domain distribution shift is detected.

Model retraining involves repeating steps 241-246 using the current data in the data source 250 along with the model feedback data 238. The AI model 232 is retrained periodically as a matter business process in order to consider the latest data and/or retrained based on a trigger, such as, but not limited to, a recent model accuracy falling below a pre-determined threshold. The model feedback data 238 is used as an input to determine the recent model accuracy. Retraining may also involve re-computing latent feature representations and re-ranking clusters from the full source dataset to re-select the refined subset used for training.

The AI production system 230 may include a user interface (not shown). The user interface may be used to manage the production system infrastructure, the components of the production system 230-238, and the operation of the AI production system and its components. The user interface may also present operational metrics related to model usage, subset stability, and classification performance across domains to aid in determining when a new refined subset selection or retraining cycle is initiated.

The instant solution may include an AI production system 230 as shown in FIG. 2C, which is configured to execute an AI model 232 trained on a dataset subset refined for domain alignment. The AI model 232 may have been generated using processes described in FIG. 2B and stored in an AI model registry 260 accessible to the production environment.

The AI production system 230 receives, via an API 234, a serialized version of the AI model 232 configured to detect objects within visual scenes. The input to the system may include image data collected on a user device, such as a mobile phone, camera-equipped scanner, or augmented reality headset. The incoming image is encapsulated in a request payload passed through the API 234 and routed to an AI server process 236 for inference execution.

The AI server process 236 may transform 237 the image data to produce valid model input, such as normalized pixel arrays or converted feature formats. Upon transformation, the AI model 232 is executed to generate one or more image-level predictions, which may include detected object categories, bounding regions, and associated confidence scores. The results are returned to the calling client as part of the API response.

In this example of the instant solution, the request may originate from an application executing on a user device, such as a field-deployed mobile system. The application transmits incoming live image input to the AI production system 230 and receives, in response, prediction outputs rendered as graphical overlays on the device interface. The overlays indicate the presence and classification of objects detected in the image using visual elements such as bounding boxes, labels, and color cues. This UI interaction is similar to the user interface (UI) 222 used in software service 140 as shown in FIG. 2A and extended via client applications.

The AI server may process 236 may log the request metadata and optionally creates a model feedback data 238 if the application supports user input on prediction accuracy. These feedback records may be streamed or retrieved by an AI development system 240 as depicted in FIG. 2C to support downstream retraining and model lifecycle management. A selected subset of labeled images, curated using cluster-based similarity techniques, may be used to configure a visual classification model that is deployed to a user device. The user device may include, for example, a mobile phone, tablet, smart glasses, body-worn sensor platform, or embedded edge processor, and is configured to execute an object detection application based on the deployed model.

The object detection application may be installed as part of a native app or containerized service that integrates with a camera module on the user device. The application includes an inference engine that loads the trained visual classification model into device memory. The model may be optimized for on-device execution using a lightweight runtime. During operation, the application continuously or periodically captures image frames from the device's onboard camera. Each image frame is preprocessed in accordance with the model's input requirements, which may include resizing, normalization, and channel alignment. The preprocessed image is passed to the loaded model, which outputs one or more predictions.

Each prediction may include one or more bounding regions indicating detected objects, corresponding class labels derived from the label space of the refined source dataset, and associated confidence scores. The application renders a user interface (UI) overlay that visually annotates the live camera feed with prediction results. This may include drawing rectangles, masks, or other graphical elements on top of each detected object along with text labels showing the predicted class and score. The interface may refresh in near real-time to reflect the current scene as captured by the camera.

Because the model has been configured based on a subset of labeled images selected for their visual similarity to the target dataset, the application is well-suited to detect and recognize objects that originate from the target environment, despite being trained on the source data. This configuration allows the application to generalize effectively across visual domains.

The user interface may allow manual override, correction, or confirmation of predictions. This interaction may be used to trigger feedback logging or model performance evaluation, which could later be ingested by a remote development system (e.g., as described in FIG. 2C) to further refine the model for future deployments. The instant solution transmits the image-level predictions to a document indexing engine that stores each prediction in association with a corresponding image identifier. After the visual classification model generates prediction outputs, such as class labels, bounding regions, and confidence scores, these outputs are packaged as a structured result object for each processed image. This result object constitutes the image-level prediction and includes metadata such as the image identifier (e.g., a unique hash, filename, timestamp, or capture session ID), the prediction timestamp, and optional provenance indicators (e.g., which version of the classification model was used).

The instant solution may include an output pipeline that transmits this image-level prediction to a document indexing engine. In some implementations, the pipeline uses a message broker or API to forward the prediction data to the indexing component asynchronously. The document indexing engine may be implemented as part of a local storage system, a remote search server, or a distributed knowledge graph database. Upon receiving the prediction, the indexing engine parses the incoming data and creates or updates an index entry corresponding to the provided image identifier. This entry stores the full prediction payload, including associated labels, bounding box coordinates if present, and classification confidence metrics. The indexed entries allow subsequent retrieval and search based on object category, detection time, image attributes, or prediction confidence.

The instant solution includes a visual classification model that is configured to adaptively update its classification parameters based on feedback generated during post-inference evaluation of incoming image data. During runtime, as new image data is received and processed by the visual classification model, the model generates prediction outputs that may include class labels, bounding regions, and confidence scores. After each inference cycle, the instant solution captures feedback that characterizes the accuracy, relevance, or precision of the model's output. This feedback may be sourced from explicit user input, such as manual corrections or confirmations provided via a user interface, or from implicit signals, such as discrepancies between model predictions and known ground truth labels retrieved from an external validation database or feedback loop subsystem. The post-inference feedback is logged and associated with the original input image data and prediction context.

The instant solution includes a performance monitoring module that analyzes the accumulated feedback to detect trends indicating degradation or drift in model accuracy. Based on predefined criteria (such as a drop below a minimum accuracy threshold, pattern-level misclassifications, or a rolling average of false positives or negatives, the monitoring module triggers an adaptive update. This update may occur on-device or via connection to a cloud-based development environment. The update process involves adjusting the model's internal weights, retraining a portion of the model using a refined dataset that includes the feedback-labeled samples, or fine-tuning hyperparameters such as learning rate, regularization strength, or feature extraction depth. In some configurations, the instant solution supports incremental learning or continual learning frameworks that enable these parameter updates to occur without full retraining. Once the model has been updated, it is revalidated and redeployed, either locally or remotely, ensuring that subsequent inferences reflect the increased accuracy of classification behavior based on the integrated feedback.

The system may identify a subset of labeled images from a source dataset that most closely aligns, based on feature similarity, with a target dataset representing a different visual domain. This selected subset is used to configure a visual classification model tailored to the visual properties of the target domain, without requiring full retraining of the model. The configured model is deployed to a user device that includes an object detection application.

The object detection application processes live or pre-recorded image input on the user device and generates output predictions that identify object categories within each frame. These predictions are rendered as visual overlays on the user interface of the device, such as bounding boxes, segmentation masks, or other highlighting indicators. The overlays identify objects that match categories related to the analyzed image data, allowing the user to interpret results in real time. This feature of the instant solution enables domain-specific object detection and visualization at the edge, even in scenarios where direct training data from the target domain is unavailable.

The instant solution may process labeled images from a source dataset and images from a target dataset to compute visual feature representations and determine cluster-to-target similarity. Based on a computed similarity ranking and a predefined selection limit, the system selects a subset of image clusters that best represent the visual characteristics of the target dataset. The selected subset of labeled images is then written to memory as a refined training corpus. This stored subset may be used to configure or fine-tune visual inference models downstream, enabling the system to preserve the most relevant training data aligned to a specific visual domain.

FIG. 2D is a system diagram 200D illustrating a chatbot service that utilizes an AI model. Referring to FIG. 2D, a computing device 110 (see FIGS. 1, 2D) may host a chatbot client 262 which interworks with a chatbot service 264 executing on a host platform 120 (see FIGS. 1, 2D). Further, the chatbot service 264 utilizes a trained chatbot AI model 266 that is resident on an AI production system 230 (see FIGS. 2A-2D). The chatbot client 262 is an example of a service client 160, depicted in FIG. 1. In some examples and features of the instant solution, the chatbot service 264 is an example of software service 140 (see FIG. 2A) which includes an API 220 (see FIG. 2A), a UI 222 (see FIG. 2A) and at least one decision subsystem 224 (see FIG. 2A). The trained chatbot AI model 266 is an example of AI model 232 (see FIGS. 2A-2C) which is hosted on an AI production system 230 (see FIGS. 2A-2D). The AI production system 230 (see FIG. 2D) includes the internal architectural elements depicted in FIG. 2C.

Although FIG. 2D illustrates a chatbot use case, the same system architecture is leveraged in the instant solution for image classification tasks where the AI model 266 is trained on a refined subset of source data optimized to classify a separate target image domain. In this context, chatbot service 264 and chatbot client 262 are analogous to services submitting visual classification queries for incoming image data.

The chatbot client 262 accepts and captures a user prompt 270 which it sends to the chatbot service 264. Upon receiving the user prompt 270, the chatbot service 264 builds a service request 272 that includes the user prompt 270. The service request 272 may include a target AI model identifier, such as an identifier to a trained chatbot AI model 266. Once built, the service request 272 is delivered to the AI production system 230 (see FIGS. 2A-2D). Upon receipt of the service request 272, the AI production system 230 determines the target AI model, such as the trained chatbot AI model 266, and extracts the user prompt 270. The AI production system transforms the user prompt 270 using Natural Language Understanding (NLU) or Natural Language Processing (NLP) techniques before delivering it to the trained chatbot AI model 266. Upon receipt of the possibly transformed user prompt 270, the trained chatbot AI model 266 determines an appropriate user response 274 and returns the user response 274 to the AI production system 230. The trained chatbot AI model 266 utilizes neural networks or Natural Language Generation (NLG) techniques in order to determine the appropriate user response 274. This workflow is adapted to process incoming image data in place of user prompts, where a visual classifier model, trained on a refined subset of labeled source images, is executed to return a classification label or prediction associated with the input image.

Upon receipt of the response, the AI production system 230 constructs and sends a service response 276 that contains the user response 274 back to the chatbot service 264. Upon receipt of the service response 276, the chatbot service 264 extracts the user response 274 and delivers it to the chatbot client 262, which emits it. In the image classification variant of the instant solution, the service response 276 includes classification output derived from inference over the refined dataset model, and the results are delivered to the requesting system or client for further action.

FIG. 2E illustrates a flow diagram 200E that depicts an end-to-end workflow for configuring, training, and deploying a visual classification model using a similarity-ranked subset of labeled images, according to examples and features of the instant solution.

At step 280, a plurality of labeled images may be provided from a source dataset 122 to a processing system 106. Each labeled image may comprise a data object associated with one or more class labels and may be stored in a local or networked image repository. The processing system 106 retrieves the labeled images via a network interface or direct memory access and may load them into working memory for analysis.

At step 282, a plurality of unlabeled images may be received from a target dataset 104. The target dataset 104 may include image data originating from a different visual domain than the source dataset 122, such that the images differ in distribution due to lighting, style, modality, acquisition conditions, etc. The target images may be provided to the processing system 106 for use in latent-space comparison.

At step 284, the processing system 106 extracts one or more feature representations from each labeled image and each target image. These features may include latent vectors generated by a pretrained model, such as a convolutional neural network or a transformer-based encoder. The processing system 106 groups the labeled images into clusters using an unsupervised algorithm (e.g., k-means) and may compute one or more similarity scores for each cluster relative to the target dataset 104. These scores may be generated using a domain alignment metric such as Central Moment Discrepancy (CMMD), and the clusters and associated scores may be transmitted to a visual model 108 or model training controller.

At step 286, a refined subset of the labeled images may be selected based on the computed similarity scores and a predefined selection constraint (e.g., top N clusters or memory size). The processing system 106 may use the constraint to filter clusters and may include the images associated with selected clusters in the training set.

At step 288, the visual model 108 may be trained using the refined subset. Training may include initializing weights, applying a loss function (e.g., cross-entropy), and executing optimization steps such as gradient descent. Data augmentation, dropout, or regularization may be applied to improve generalization. The model may be validated during or after training using a hold-out dataset.

At step 290, the visual model 108 generates a signal or flag indicating that it is ready for inference. This readiness notification may be received by a chatbot application 109.

At step 292, a user device 112 may transmit an input image to the chatbot application 109. The input image may be captured via a client interface, such as chatbot client 262 (see FIG. 2D), and may be embedded into a service request similar to service request 272.

At step 294, the chatbot application 109 may trigger execution of the trained visual model 108 using the transmitted image. The visual model 108 may generate one or more classification results by applying learned feature mappings to the image data.

At step 296, the output of the visual model 108 may include one or more labels, probability scores, or detection regions. This output may be returned to the chatbot application 110 and may be formatted into a structured response.

At step 298, the chatbot application 109 may deliver the response to the user device 112, where the result may be presented as a label, annotation, or classification decision via the client interface.

The flow depicted in FIG. 2E enables the instant solution to achieve domain-adaptive image classification while minimizing computational overhead by selecting the most semantically relevant training data. Each step may be implemented using discrete software modules or services executing on distributed systems, such as those shown in FIG. 2D.

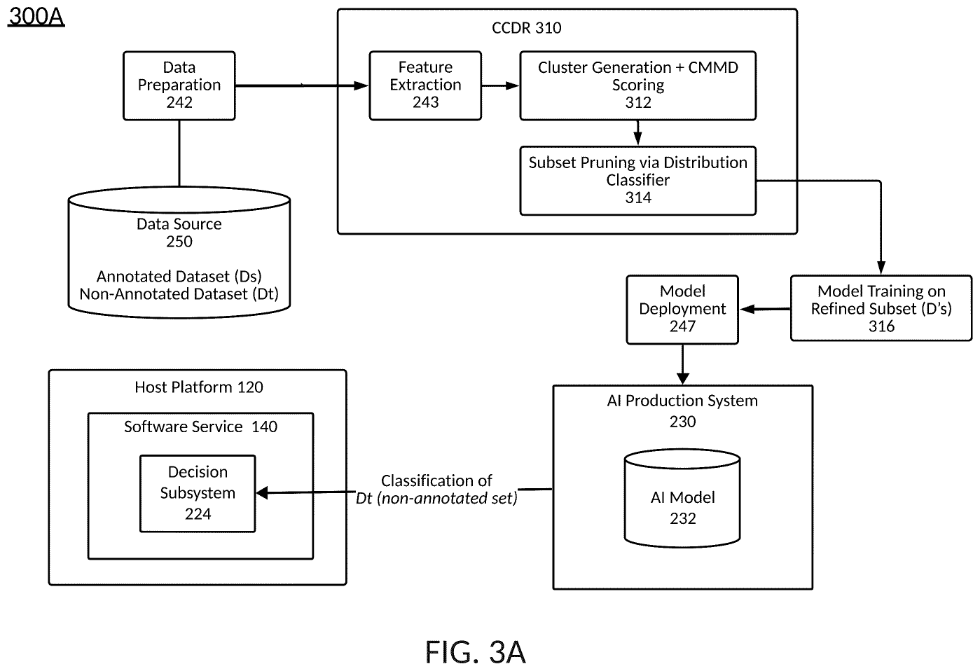

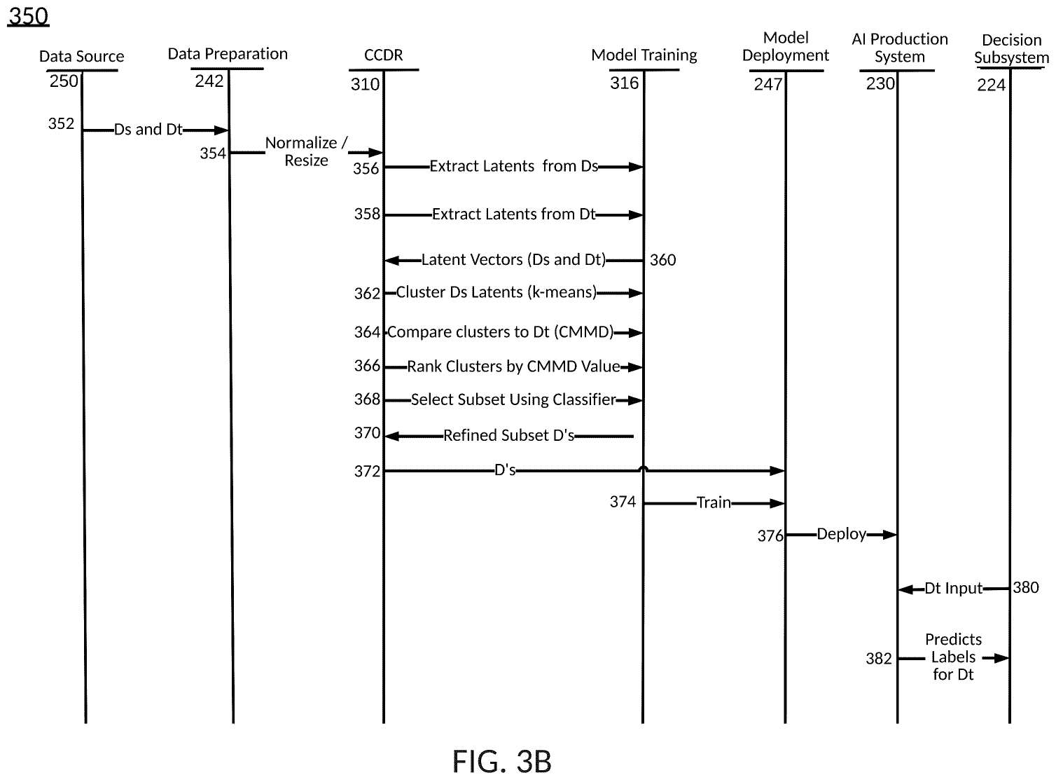

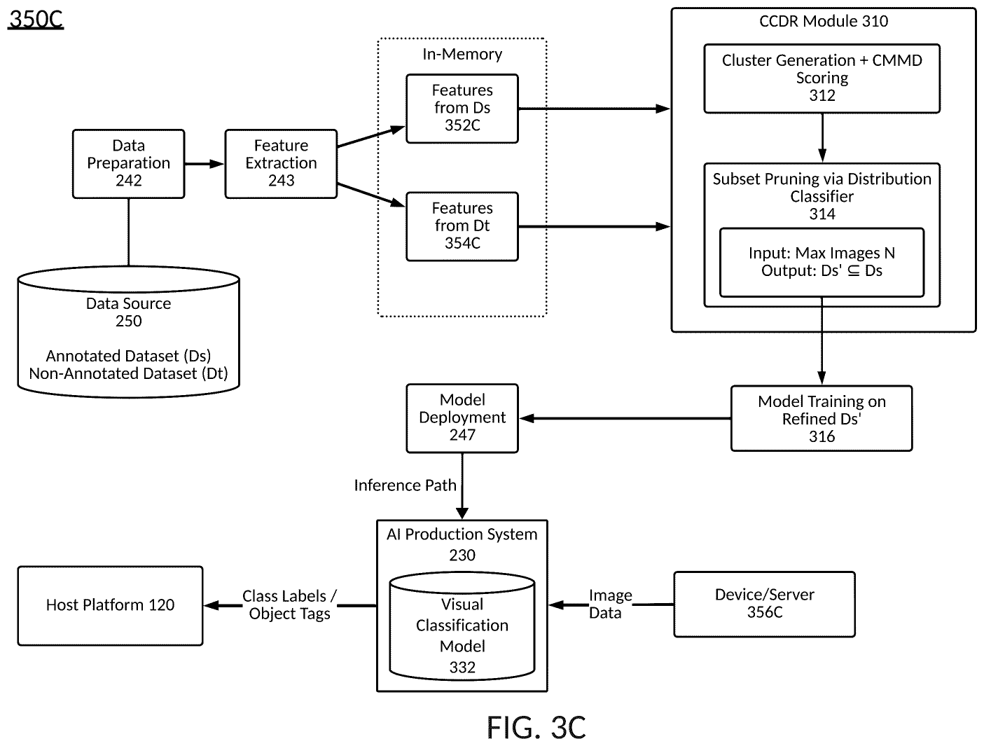

FIG. 3A illustrates a system-level architecture 300A for generating, training, and deploying a domain-adaptive AI model for classification of unlabeled images from a distinct target domain, according to examples and features of the instant solution. The system shown in FIG. 3A includes data processing, cluster-driven selection, model training, deployment, and real-time classification, and may operate across multiple networked computing environments.

A data source 250 is shown as including at least two datasets: an annotated dataset Ds comprising a plurality of labeled images, and a non-annotated dataset Dt comprising a plurality of unlabeled images. The data source 250 may be a centralized repository, distributed object store, or hybrid storage layer accessible via the processing infrastructure.

The data preparation module 242, consistent with that described in FIG. 2B, step 242, may receive raw images from the data source 250 and perform operations such as format normalization, resizing, deduplication, and noise filtering. The prepared data is forwarded to a feature extraction module 243, which may apply a pretrained encoder model, such as a vision transformer or convolutional backbone, to compute latent feature vectors for each image in both Ds and Dt. This stage corresponds functionally to feature processing as described in step 206E of FIG. 2E and step 243 of FIG. 2B.

The latent features output from the feature extraction module 243 are received by cluster generation+CMMD scoring 312, which resides within a larger component referred to as CCDR 310 (Classifier-Guided Cluster Refinement). Within cluster generation+CMMD scoring 312, images from the annotated dataset Ds may be grouped into clusters using unsupervised learning (e.g., k-means), and each cluster may be evaluated with respect to the non-annotated dataset Dt using a domain alignment metric such as CMMD. Each cluster may be assigned a score indicating how well its content distribution matches that of the target domain.

The subset pruning via distribution classifier 314 performs refinement of Ds by applying a learned distribution classifier to the ranked clusters. This classifier may be a neural network trained to detect whether a cluster is relevant to the target domain distribution. Clusters above a confidence threshold or within a budget constraint (e.g., top-k clusters) may be selected. The output of subset pruning via distribution classifier 314 is a refined subset D's, a labeled image collection that retains high target-domain alignment with minimal redundancy.

The refined dataset D's is then passed to a model training module 316, which may perform supervised learning by training a neural classifier using the selected images. Training may include initialization, optimization (e.g., stochastic gradient descent), validation, and checkpointing of weights. This stage aligns with training behavior previously described in step 210E of FIG. 2E and step 245 of FIG. 2B.

Upon completion of training, the resulting AI model is deployed through a model deployment interface 247 into an AI production system 230, where it is registered as an AI model 232. The deployment process may include packaging the model, storing it in an AI model registry 260 (see FIG. 2B), and initializing runtime services capable of loading and executing the model in response to classification requests.

Once deployed, the AI model 232 may be invoked by a decision subsystem 224, which is part of a software service 140 executing on a host platform 120. This decision subsystem 224 may include service logic that receives incoming image inputs, applies inference through the AI model 232, and returns classification results. This service interaction mirrors the workflow shown in FIG. 2D, where a service request (e.g., 272) triggers model execution and generates a user-facing response (e.g., 276, 274).

An example operation may include converting an annotated dataset loaded from a storage into a first set of latents, converting a non-annotated dataset loaded from the storage into a second set of latents, clustering the first set of latents into a plurality of clusters, determining a discrepancy score for each cluster in the plurality of clusters and the second set of latents, wherein the discrepancy score of a cluster is a measure of resemblance between the first set of latents and the second set of latents, creating a refined subset of data from the annotated dataset by including at least one data from each cluster of the plurality of clusters when adding the at least one data lowers the discrepancy score of the refined subset of data and the second set of latents, and reducing computational processing of a trained Artificial Intelligence model configured to classify data from the non-annotated dataset by using the refined subset of data from the annotated dataset to classify data from the non-annotated dataset.

The example operation may also include the annotated dataset being an annotated set of images and the latents determined using a Vision Transformer (ViT), the annotated dataset being an annotated set of images, wherein the annotated set of images are processed by a Contrastive Language-Image Pretraining (CLIP) model, the clustering comprising partitioning the first set of latents into the plurality of clusters using k-means clustering, the discrepancy score being determined by a CLIP Maximum Mean Discrepancy (CMMD) value, ranking clusters in an ascending order based on a CLIP Maximum Mean Discrepancy (CMMD) value, and the determining of the discrepancy score comprising determining differences between mean values of the first set of latents.

FIG. 3B illustrates an operational flow 350 for training and deploying a visual classification model using a refined subset of annotated data, according to examples and features of the instant solution. The flow spans seven functional roles: data source 250, data preparation 242, CCDR 310, model training 316, model deployment 247, AI production system 230, and decision subsystem 224. Each numbered interaction corresponds to a technically discrete processing step executed by one or more modules in the system.

At step 352, both an annotated dataset Ds and a non-annotated dataset Dt are received from a data source 250. The dataset Ds may include image samples paired with one or more classification labels, while dataset Dt may contain unlabeled images drawn from a visually distinct domain. At step 354, the data is transmitted to a data preparation module 242, which may normalize the images to a common scale and aspect ratio, convert formats, or filter invalid or corrupted data. This prepares both datasets for feature embedding and downstream processing.

At step 356, the prepared images from Ds are passed into a CCDR 310 module, which begins by extracting latent representations. Feature vectors may be generated using a frozen encoder model such as a convolutional neural network, a visual transformer, or any encoder suitable for generating semantically rich embeddings. At step 358, a corresponding latent feature extraction is performed on images in Dt using the same embedding pipeline to maintain vector space consistency. This enables fair comparison between the labeled and unlabeled distributions.

At step 360, the latent vectors for both datasets are collected and forwarded to the clustering component of CCDR 310. At step 362, the latent features from Ds are grouped using an unsupervised clustering algorithm, such as k-means. Each resulting cluster may be interpreted as capturing a distinct visual theme or structural similarity group. At step 364, the centroid or distribution of each cluster is compared to the latent distribution of the target dataset Dt using a statistical distance metric. In one example of the instant solution, this metric may include Central Moment Discrepancy (CMMD), which measures the similarity between higher-order moments of two distributions.

At step 366, the clusters are ranked by their CMMD scores to determine their alignment with the target domain. Clusters more similar to Dt will receive higher rankings. At step 368, a refined subset of Ds is selected using a learned classifier. The classifier may be trained to identify cluster relevance, and may enforce constraints such as maximum subset size, coverage threshold, or computational budget.

At step 370, the selected subset D's is finalized and returned to CCDR 310. This subset may be substantially smaller than Ds while retaining domain-relevant structure. At step 372, the refined dataset D's is provided to a model training module 316. At step 374, model training is initiated using the D's dataset. Training may include backpropagation over a classification head, regularization, learning rate scheduling, and early stopping based on validation loss.

At step 376, the trained model is deployed into the AI production system 230 via a model deployment controller 247. Deployment may include serializing weights, storing the model in a registry, and initializing the model within a runtime environment for live inference. At step 380, the deployed model in the AI production system 230 receives a new image input from the dataset Dt. This image may be sent via a classification request originated from a client application or automated agent. At step 382, the model processes the input image and predicts a class label. The output is returned to a decision subsystem 224, which may format the prediction into a downstream action, display element, or record.

FIG. 3C illustrates a classifier-guided system architecture 350C for domain-aligned training and deployment of a visual classification model using a selectively refined subset of labeled training images. The system integrates multiple modules that operate in memory or across distributed computing infrastructure to receive image data, extract semantic features, construct inter-domain alignment metrics, and execute inference operations on unseen image inputs. The depicted components include feature-processing, cluster-ranking, model training, and deployment subsystems.

A data source 250 stores and supplies at least two distinct datasets: an annotated dataset (Ds) comprising a plurality of labeled images, and a non-annotated dataset (Dt) comprising a plurality of unlabeled images. The datasets may be stored in a network-accessible storage layer, object database, or cloud-native data lake. Images within Ds may include pixel data paired with one or more human-generated category labels or annotations, while images in Dt may lack any prior class association and may originate from a different visual or domain context (e.g., different lighting, sensor, image source, or content distribution).

Image samples from the data source 250 are first received by a data preparation module 242, which may apply one or more preprocessing techniques to ensure compatibility with downstream embedding processes. These techniques may include standardizing image dimensions, converting image formats to a common encoding (e.g., RGB JPEG or PNG), normalizing pixel intensity values, cropping, de-noising, and masking invalid regions. Metadata associated with each image, such as timestamps or source device identifiers, may also be preserved for audit or retraining purposes.

The output of the data preparation module 242 is processed by a feature extraction module 243, which computes one or more latent representations for each image. These representations are numerical feature vectors that encode semantic visual characteristics such as color structure, edge boundaries, texture, or object layout. The feature extraction module 243 may include a pretrained neural network encoder (e.g., a vision transformer, convolutional feature pyramid, etc.). As shown in the figure, the resulting features from Ds (352C) and features from Dt (354C) are stored temporarily in memory as part of an in-memory feature pool. These in-memory vectors are then used by downstream components for alignment evaluation and cluster analysis.

The feature vectors are provided to a CCDR 310 module, which executes classifier-guided domain refinement. The CCDR 310 module includes at least two components: a cluster generation+CMMD scoring 312 module, and subset pruning via distribution classifier 314. The cluster generation+CMMD scoring 312 module groups feature vectors extracted from Ds into clusters using an unsupervised learning algorithm, such as k-means or DBSCAN. Each cluster may represent a subset of semantically similar images (e.g., those depicting similar objects or scene types). The module computes an alignment score for each cluster relative to the target dataset Dt. This score may be based on a statistical divergence or distribution alignment metric, such as Central Moment Discrepancy (CMMD), kernel Maximum Mean Discrepancy (MMD), cosine similarity, or another cross-domain comparison function. The scoring metric may compare cluster centroids or higher-order distributional properties between Ds and Dt to determine inter-domain proximity.

The ranked list of clusters is then passed to subset pruning via distribution classifier 314, which filters the list according to a specified constraint. This constraint may define a maximum number of training samples (N), a selection budget, a minimum similarity threshold, or a model memory capacity. The top-ranked clusters are selected, and the images contained in those clusters form a refined subset D's. This subset is forwarded to a training module and contains those labeled images that are likely to generalize to the visual characteristics of the target dataset Dt.

A model training module 316 receives the refined subset D's and initiates supervised training. Training may include shuffling, minibatch construction, forward and backward propagation, gradient descent, and validation. The model architecture used for training may be a convolutional neural network, transformer-based classifier, or another deep learning model. Additional training procedures may include regularization (e.g., dropout), learning rate scheduling, and early stopping. The trained model may be validated against a holdout subset of D's or a synthetic proxy dataset.

Once the training process completes, the resulting model is transferred to a model deployment module 247, which serializes the model and transfers it to a production inference system. The model is then instantiated as a visual classification model 332, which is an example of AI model 232 described and depicted in FIGS. 2A-2C and executes within an AI production system 230. The production system may include a model runtime service, memory and compute resources, containerized orchestration support, and logging tools.

The visual classification model 332 becomes accessible via an inference path. Incoming image data may be provided by a device or server 356C, which may include a camera feed, document scanner, edge sensor, mobile phone, or remote storage proxy. The image data is passed into the production model, which executes forward inference to generate predicted labels, category scores, object tags, bounding boxes, or segmentation masks depending on the model's architecture.

After inference, the output is returned to a host platform 120, which may include a service layer that formats and integrates the predictions into downstream tasks such as document indexing, content tagging, image retrieval, or user alerting. The result may be logged, visualized, or stored along with metadata for traceability and potential retraining.

After the subset of labeled images has been selected and stored in memory the at least one processor retrieves the subset of labeled images and uses them to train or configure the visual classification model 332. The labeled image subset stored in memory may include pre-associated category labels that allow the system to utilize supervised learning techniques during model training. In some examples, the training process is executed within a machine learning module hosted in an AI development or inference environment that includes configurable model pipelines.

As shown in FIG. 3C, the processor uses the image subset to prepare training inputs, possibly applying preprocessing operations such as resizing, normalization, and augmentation (e.g., rotations, flips) to increase model robustness across varied visual conditions. The classification model 332 may be a convolutional neural network (CNN), a transformer-based model, or another neural architecture optimized for feature-based visual recognition. In examples where the model is initialized from a pre-trained backbone, the training step may involve domain-specific fine-tuning using the selected subset, thereby avoiding full retraining on the complete source dataset.

Once visual classification model 332 is trained or configured, it is deployed to process subsequent image data, such as incoming image streams. The classification model is applied to analyze the features of each incoming image and produce an output comprising at least one predicted category label and an associated confidence score. The output for each image may be used to annotate, categorize, or otherwise enrich the downstream processing pipeline (e.g., indexing or retrieval services). In some implementations, the confidence score is used to gate further system actions, such as image retention, alert generation, or visual overlay display, based on a minimum certainty threshold. The results may also be optionally displayed on a user interface or transmitted to a connected system for further evaluation or action.

The system may be further configured to adaptively update the visual classification model based on feedback received from post-inference evaluation of the incoming image data. As shown in FIG. 3C, once image data is analyzed by the visual classification model 332 and prediction results are generated, those results may be compared against externally validated labels, user-provided annotations, or system-detected discrepancies. The feedback may include confirmation of correct classification, identification of incorrect labels, or cases where classification confidence falls below a predefined threshold. This feedback is logged and processed to identify performance drift or underrepresented classes in the original subset of labeled images. The processor may use this feedback to retrain or fine-tune the visual classification model 332, using either a modified version of the stored image subset or incorporating new images that reflect recent edge cases or misclassified examples. The update cycle may occur periodically or be triggered by conditions such as a sustained drop in accuracy metrics or increased feedback volume, thereby allowing the model to remain aligned with the target dataset's evolving characteristics without requiring a full retraining from scratch.

After updating the visual classification model as previously described, the system may be configured to analyze incoming image data and generate, for each analyzed image, a prediction output that includes one or more bounding regions and associated category labels. For example, the incoming image data may be received at the image input flow and processed by the trained visual classification model 332. The model may apply region-based object detection techniques to locate distinct areas of interest within the image and define bounding regions that spatially isolate those areas. Each bounding region is then assigned a category label representing the type of object detected, such as a vehicle, a symbol, or a document field, based on the model's learned feature representations. The output generated by the system includes the bounding region coordinates along with the associated category label for each identified object. This structured output may be stored, transmitted, or rendered for downstream processing, enabling a range of applications including automated labeling, user interface overlays, and semantic indexing of image content.

The system may be configured to determine the similarity ranking of the image clusters based on an approximation of how well the visual characteristics of each cluster reflect patterns observed in the target dataset. After the labeled images are grouped into image clusters and feature representations are extracted, the processor analyzes the visual distribution of features within each cluster relative to the visual patterns found in the target image data received. Instead of relying on strict mathematical scoring or distance metrics, the system may evaluate similarity by approximating the overall visual context, such as common shapes, textures, color histograms, or semantic cues, that appear more frequently in the target dataset. Clusters that exhibit visual features more representative of the target dataset (i.e., those whose internal feature patterns more closely align with those observed in the target dataset) are ranked higher than clusters with weaker visual correspondence. This relative ranking may influence the subsequent selection of labeled images for model configuration, ensuring that the resulting classification model is better adapted to the visual environment of the target dataset without requiring retraining on the full set of source data.

The system may be configured to select the subset of labeled images based on a determination that the visual characteristics of their corresponding image clusters match types of scenes, objects, or textures found in the target dataset to a degree that exceeds a defined threshold. Once the feature representations have been extracted and the labeled images grouped into image clusters, the processor analyzes each cluster in relation to the feature distribution derived from the received target dataset. For each cluster, the system evaluates visual similarity using characteristics such as object contours, spatial arrangements, lighting profiles, or domain-specific textures commonly found in the target dataset. These characteristics are assessed holistically or using approximated matching logic to determine whether they sufficiently align with the visual domain of the target data. A threshold, which may be tunable, governs the selection process, and clusters whose visual profiles exceed this threshold are used to extract labeled images for the final subset stored. This ensures that the most contextually relevant training data is used for configuring the visual classification model, promoting higher accuracy and reducing the inclusion of visually dissimilar data.

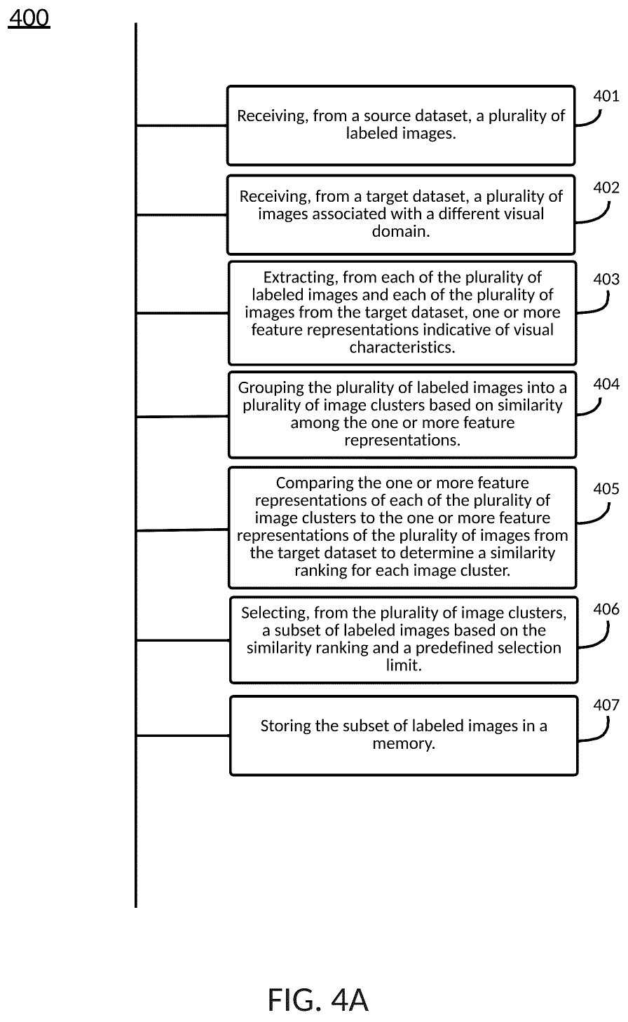

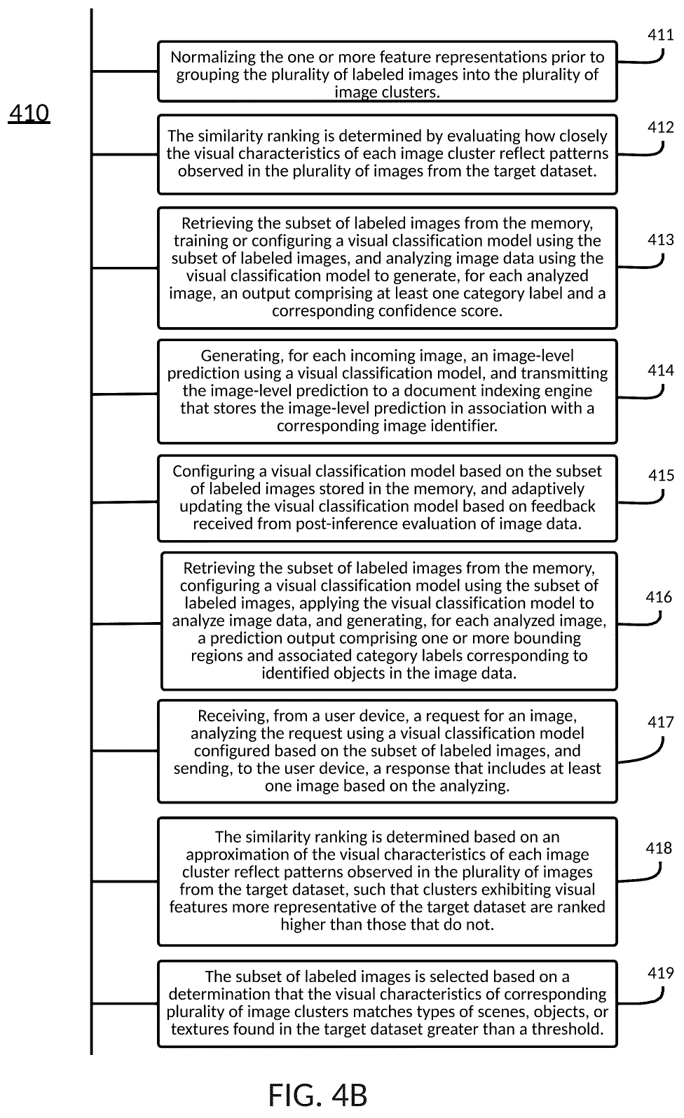

FIG. 4A illustrates an example of a method 400 for the optimized dataset reduction via cluster comparison and distribution scoring service that enables automated selection of a subset of annotated data, according to the instant solution. As an example, the method 400 may be performed by a computing system, a software application, a server, a cloud platform, a combination of systems, and the like. Referring to FIG. 4A, in 401, the method may include receiving, from a source dataset, a plurality of labeled images. In Step 402, the method may include receiving, from a target dataset, a plurality of images associated with a different visual domain. In Step 403, the method may include extracting, from each of the plurality of labeled images and each of the plurality of images from the target dataset, one or more feature representations indicative of visual characteristics. In Step 404, the method may include grouping the plurality of labeled images into a plurality of image clusters based on similarity among the one or more feature representations. In Step 405, the method may include comparing the one or more feature representations of each of the plurality of image clusters to the one or more feature representations of the plurality of images from the target dataset to determine a similarity ranking for each image cluster. In Step 406, the method may include selecting, from the plurality of image clusters, a subset of labeled images based on the similarity ranking and a predefined selection limit. In Step 407, the method may include storing the subset of labeled images in a memory.

FIG. 4B illustrates a method 410 for the optimized dataset reduction via cluster comparison and distribution scoring according to other examples and features of the instant solution. As an example, the method 410 may be performed by a computing system, a software application, a server, a cloud platform, a combination of systems, and the like. Referring to FIG. 4B, in 411, the method may include normalizing the one or more feature representations prior to grouping the plurality of labeled images into the plurality of image clusters. In step 412, the method may include the similarity ranking being determined by evaluating how closely the visual characteristics of each image cluster reflect patterns observed in the plurality of images from the target dataset. In step 413, the method may include retrieving the subset of labeled images from the memory, training or configuring a visual classification model using the subset of labeled images and analyzing image data using the visual classification model to generate, for each analyzed image, an output comprising at least one category label and a corresponding confidence score. In step 414, the method may include generating, for each incoming image, an image-level prediction using a visual classification model, and transmitting the image-level prediction to a document indexing engine that stores the image-level prediction in association with a corresponding image identifier. In step 415, the method may include configuring a visual classification model based on the subset of labeled images stored in the memory, and adaptively updating the visual classification model based on feedback received from post-inference evaluation of image data. In step 416, the method may include retrieving the subset of labeled images from the memory, configuring a visual classification model using the subset of labeled images, applying the visual classification model to analyze image data, and generating, for each analyzed image, a prediction output comprising one or more bounding regions and associated category labels corresponding to identified objects in the image data. In step 417, the method may include receiving, from a user device, a request for an image, analyzing the request using a visual classification model configured based on the subset of labeled images, and sending, to the user device, a response that includes at least one image based on the analyzing. In step 418, the method may include the similarity ranking being determined based on an approximation of the of: visual characteristics of each image cluster reflect patterns observed in the plurality of images from the target dataset, such that clusters exhibiting visual features more representative of the target dataset are ranked higher than those that do not. In step 419, the method may include the subset of labeled images being selected based on a determination that the visual characteristics of corresponding plurality of image clusters matches types of scenes, objects, or textures found in the target dataset greater than a threshold.

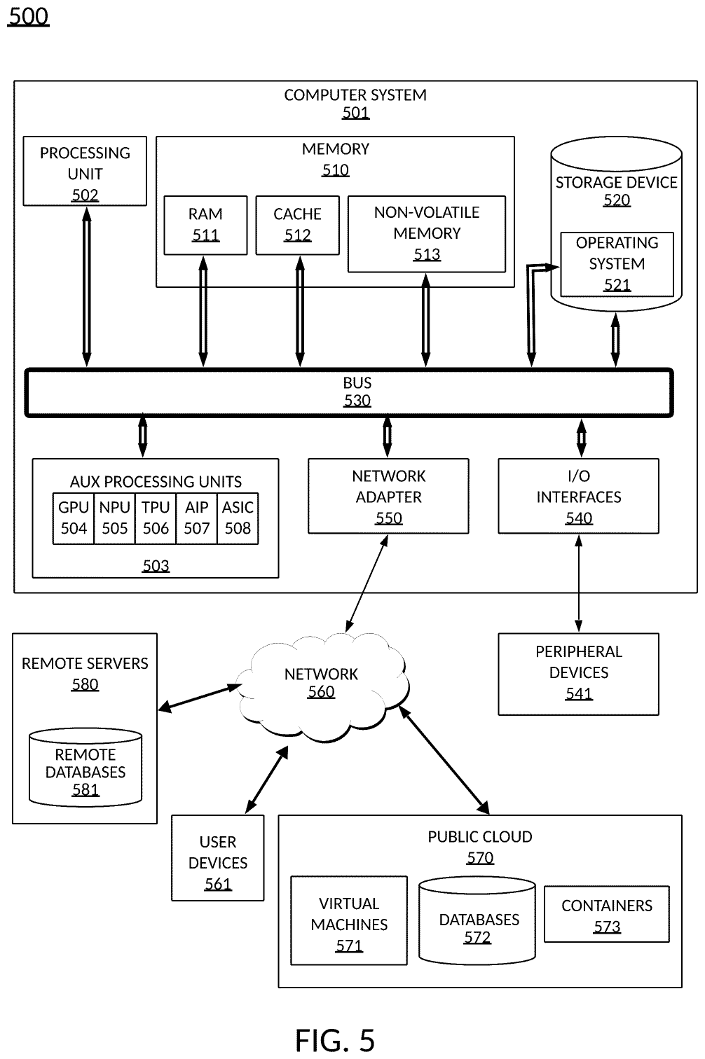

The examples and features of the instant solution may be implemented in at least one of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

The Auxiliary Processing Units (APU) 503 may contain at least one Graphics Processing Unit (GPU) 504, Neural Processing Unit (NPU) 505, Processing Unit (TPU) 506, AI Processor (AIP) 507, or other Application Specific Integrated Circuit (ASIC) 508. The at least one APU 503 may contain circuitry distributed over multiple integrated circuit chips. Each APU 503 may implement multiple processor threads and multiple processor cores. Each APU 503 may include at least one of onboard memory, onboard memory cache, and onboard instruction cache. Each APU may be communicatively coupled to the system bus 530 and configure to communicate with other system components, including a processing unit 502, system cache 512, RAM 511, non-volatile RAM 513, operating system 521, Network adapter 550, and Input/Output interfaces 540. In some computing environments, at least one of the at least one APU 503 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing device. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

The system architecture illustrated in FIG. 3A operates within the exemplary computing environment shown in FIG. 5 to perform classifier-guided dataset refinement and model deployment. As shown in FIG. 3A, a data source 250 provides both an annotated dataset (Ds) and a non-annotated dataset (Dt), which are loaded into a data preparation module 242. This module executes preprocessing operations, such as format standardization and normalization, and may be deployed on a general-purpose processor 506 within computing device 501, supported by memory 510 (e.g., RAM 511 and cache 512).

After preprocessing, the data is passed to the classifier-guided clustering and domain refinement (CCDR 310) module. Within this module, feature extraction 243 generates latent representations of images using pretrained models (e.g., CLIP, VIT). This step may be executed on specialized compute hardware, such as a graphics processing unit (GPU) 504, tensor processing unit (TPU) 506, or AI processor (AIP) 507, depending on the type of embedding model used. The latent vectors from Ds are then clustered by cluster generation+CMMD scoring 312, which compares clusters against Dt latents to compute discrepancy scores.

The distribution classifier and pruning engine 314 evaluates whether each cluster is to be retained in a refined subset of labeled data, based on whether the inclusion reduces the discrepancy score. These operations may benefit from the auxiliary processing unit 503, which includes domain-specific accelerators like application-specific integrated circuits (ASICs) 508.

Once the refined subset is determined, the data is passed to a model training module 316, where a visual classification model is trained or configured. This module may operate on a cloud-deployed server 520, or across a virtualized environment such as virtual machines 571 or containers 573, with workloads orchestrated over a network 560 using network adapter 550.

The trained model is then deployed through model deployment logic 247 into an AI production system 230, where it becomes accessible to decision pipelines. Inference is triggered via decision subsystem 224, which receives input from downstream software services or user devices and delivers classification predictions in real-time. Data flow across these modules is coordinated over the bus 530, while persistent datasets, trained models, and inference outputs may be stored in non-volatile memory 513 or storage device 520. As shown in FIG. 5, the system may also include connections to remote user devices 561, databases 572, or peripherals 541, enabling scalable interaction between core AI modules and external systems.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

Some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

The instant solution provides a technically advantageous and practically grounded approach to efficiently tailoring annotated training data using adaptive classifier guidance and vector representation analysis. By applying a shared transformer encoder to both a fully annotated source dataset and a second dataset of target prompts that may not include labels, the system constructs latent representations that encapsulate semantic relationships and structural features within both data sets. These embeddings are then used to build a vector graph, from which clusters of similar source examples are derived. The system subsequently applies a domain-adaptive classifier, which has been trained to detect domain divergence, to score source examples within each cluster based on their similarity to the target domain. This targeted scoring mechanism allows the system to identify and select only the most domain-representative annotated samples from the source dataset.

This reduced, high-fidelity training subset offers several concrete operational benefits. First, it reduces the computational overhead required for model training, resulting in faster convergence and lower resource consumption. Second, it enables the trained models to generalize more effectively to the intended inference environment, particularly when the target inputs differ significantly from the distribution of the original annotated dataset. Third, it reduces annotation effort by eliminating the need to label target domain data, instead using domain-guided selection of relevant examples. When deployed, the trained models can deliver real-time or asynchronous predictions for target prompts with enhanced contextual alignment and robustness, making the instant solution highly applicable in fields like prompt classification, language-guided generation control, or any use case where domain-specific language inputs require nuanced model behavior.

A machine learning engineer, data specialist, or AI system architect, interacts with the instant solution through a software interface that exposes both data input tools and configuration controls. Initially, the user uploads a fully annotated dataset along with a set of target prompts, which may originate from an inference pipeline, end-user inputs, or unlabeled test corpora. Upon submission, the system applies a transformer encoder to both datasets and presents the resulting latent vectors through an interactive visualization interface. The user can examine the spatial relationships and clustering patterns among the embeddings, gaining insight into the alignment between source and target domains.

As the system constructs vector graphs and evaluates source samples using the domain-adaptive classifier, the user is provided with access to scoring metrics and cluster-level summaries. The interface may support slider or toggle-based controls to adjust clustering thresholds or divergence sensitivity, allowing the user to influence how tightly the selected subset aligns with the target prompts. In some implementations, the user can review and override system decisions, for example, re-including an outlier sample that carries known relevance or excluding an anomalous point that passed classifier scoring. Once the reduced dataset is finalized, the user can trigger model training, monitor training performance, and validate classifier behavior against held-out or real-time prompts.

What is claimed is:

1. A system, comprising:
a memory; and
at least one processor communicatively coupled to the memory, wherein the at least one processor is configured to:
receive, from a source dataset, a plurality of labeled images;
receive, from a target dataset, a plurality of images associated with a different visual domain;
extract, from each of the plurality of labeled images and each of the plurality of images from the target dataset, one or more feature representations indicative of visual characteristics;
group the plurality of labeled images into a plurality of image clusters based on similarity among the one or more feature representations;
compare the one or more feature representations of each of the plurality of image clusters to the one or more feature representations of the plurality of images from the target dataset to determine a similarity ranking for each image cluster;
select, from the plurality of image clusters, a subset of labeled images based on the similarity ranking and a selection limit; and
store, in the memory, the subset of labeled images.

2. The system of claim 1, wherein the at least one processor is further configured to normalize the one or more feature representations prior to grouping the plurality of labeled images into the plurality of image clusters.

3. The system of claim 1, wherein the similarity ranking is determined using a distance score based on a comparison between average feature vectors of each image cluster and feature vectors of the plurality of images from the target dataset.

4. The system of claim 1, wherein the at least one processor is further configured to:
retrieve the subset of labeled images from the memory;
train or configure a visual classification model using the subset of labeled images; and
apply the visual classification model to analyze subsequent image data and generate, for each analyzed image, an output comprising at least one category label and a corresponding confidence score.

5. The system of claim 1, wherein the at least one processor is further configured to generate, for each incoming image, a prediction output comprising an image-level prediction, and to transmit the image-level prediction to a document indexing engine that stores the image-level prediction in association with a corresponding image identifier.

6. The system of claim 1, wherein the at least one processor is further configured to:
configure a visual classification model based on the subset of labeled images stored in the memory; and
adaptively update the visual classification model based on feedback received from post-inference evaluation of incoming image data.

7. The system of claim 1, wherein the at least one processor is further configured to:
retrieve the subset of labeled images from the memory;
configure a visual classification model using the subset of labeled images;
apply the visual classification model to analyze image data; and
generate, for each analyzed image, a prediction output comprising one or more bounding regions and associated category labels corresponding to identified objects in the image data.

8. The system of claim 1, wherein the at least one processor is further configured to:
receive, from a user device, a request for an image;
analyze the request by a visual classification model that is configured based on the subset of labeled images; and
send, to the user device, a response that includes at least one image based on the analyze.

9. The system of claim 1, wherein the similarity ranking is determined based on an approximation of the visual characteristics of each image cluster reflect patterns observed in the plurality of images from the target dataset, such that clusters exhibiting visual features more representative of the target dataset are ranked higher than those that do not.

10. The system of claim 1, wherein the subset of labeled images is selected based on a determination that the visual characteristics of corresponding plurality of image clusters matches types of scenes, objects, or textures found in the target dataset greater than a threshold.

11. A method, comprising:
receiving, from a source dataset, a plurality of labeled images;
receiving, from a target dataset, a plurality of images associated with a different visual domain;
extracting, from each of the plurality of labeled images and each of the plurality of images from the target dataset, one or more feature representations indicative of visual characteristics;
grouping the plurality of labeled images into a plurality of image clusters based on similarity among the one or more feature representations;
comparing the one or more feature representations of each of the plurality of image clusters to the one or more feature representations of the plurality of images from the target dataset to determine a similarity ranking for each image cluster;
selecting, from the plurality of image clusters, a subset of labeled images based on the similarity ranking and a selection limit; and
storing the subset of labeled images in a memory.

12. The method of claim 11, further comprising normalizing the one or more feature representations prior to grouping the plurality of labeled images into the plurality of image clusters.

13. The method of claim 11, wherein the similarity ranking is determined by evaluating how closely the visual characteristics of each image cluster reflect patterns observed in the plurality of images from the target dataset.

14. The method of claim 11, further comprising:
retrieving the subset of labeled images from the memory;
training or configuring a visual classification model using the subset of labeled images; and
analyzing image data using the visual classification model to generate, for each analyzed image, an output comprising at least one category label and a corresponding confidence score.

15. The method of claim 11, further comprising:
generating, for each incoming image, an image-level prediction using a visual classification model; and
transmitting the image-level prediction to a document indexing engine that stores the image-level prediction in association with a corresponding image identifier.

16. The method of claim 11, further comprising:
configuring a visual classification model based on the subset of labeled images stored in the memory; and
adaptively updating the visual classification model based on feedback received from post-inference evaluation of image data.

17. The method of claim 11, further comprising:
retrieving the subset of labeled images from the memory;
configuring a visual classification model using the subset of labeled images;
applying the visual classification model to analyze image data; and
generating, for each analyzed image, a prediction output comprising one or more bounding regions and associated category labels corresponding to identified objects in the image data.

18. The method of claim 11, further comprising:
receiving, from a user device, a request for an image;
analyzing the request using a visual classification model configured based on the subset of labeled images; and
sending, to the user device, a response that includes at least one image based on the analyzing.

19. The method of claim 11, wherein selecting the subset of labeled images comprises identifying clusters whose visual characteristics more closely resemble scenes, objects, or textures found in the target dataset compared to other clusters.

20. A computer program product, comprising:
at least one computer-readable storage media; and
program instructions stored on the at least one computer-readable storage media to perform operations comprising:
receiving, from a source dataset, a plurality of labeled images;
receiving, from a target dataset, a plurality of images associated with a different visual domain;
extracting, from each of the plurality of labeled images and each of the plurality of images from the target dataset, one or more feature representations indicative of visual characteristics;
grouping the plurality of labeled images into a plurality of image clusters based on similarity among the one or more feature representations;
comparing the one or more feature representations of each of the plurality of image clusters to the one or more feature representations of the plurality of images from the target dataset to determine a similarity ranking for each image cluster;
selecting, from the plurality of image clusters, a subset of labeled images based on the similarity ranking and a selection limit; and
storing the subset of labeled images in a memory.
